(19) United States
(12) Patent Application Publication
(10) Pub. No.: US 2024/0403669 A1
(43) Pub. Date: Dec. 5, 2024

(54) QUESTION ANSWERING DEVICE, QUESTION ANSWERING METHOD, AND PROGRAM

(71) Applicant: NIPPON TELEGRAPH AND TELEPHONE CORPORATION, Tokyo (JP)

(72) Inventors: Kaname KASAHARA, Tokyo (JP); Yuichiro SEKIGUCHI, Tokyo (JP)

(73) Assignee: NIPPON TELEGRAPH AND TELEPHONE CORPORATION, Tokyo (JP)

(21) Appl. No.: 18/691,613

(22) PCT Filed: Sep. 15, 2021
(86) PCT No.: PCT/JP2021/033986

§ 371 Date: Mar. 13, 2024

(51) Int. Cl. G06N 5/04

(52) U.S. Cl. CPC G06N 5/04

(57) ABSTRACT

A question and answer device 100 that generates answer data in response to question data includes a question determination unit 10 that receives a predetermined question type into which a feature of the question data is classified and the passage data matching the question data, determines whether machine reading is necessary on the basis of the question type, sets the passage data as the answer data when determining that the machine reading is not necessary, and sets answer text data extracted from the passage data by the machine reading as the answer data on the basis of the question data and the passage data when determining that the machine reading is necessary.

### TECHNICAL FIELD

The present disclosure relates to a question and answer device, a question and answer method, and a program.

### BACKGROUND ART

Question and answer techniques for causing a computer to automatically generate an answer to a question input in a natural language by a user have been attracting attention these days. As one of such question and answer techniques, there is a known extractive machine reading for extracting an answer portion from a document written in a natural language, in response to a question that has been input also in a natural language (see Non Patent Literature 1, for example). By a question and answer technique that involves machine reading, a neural network is used to check a question against answer portions written in a document such as an instruction manual, and it is known that an answer accuracy equal to or higher than that of a person can be achieved in question and response tasks of a one-to-one type (see Non Patent Literature 2, for example). In extractive neural machine reading, on the other hand, a computer is often required to be equipped with a graphic processing unit (GPU) not only at a time of learning but also at a time of inference, and the processing time tends to be longer than that required by a question and answer technique that does not use a neural network.

One of the applications of the question and answer technique that involves machine reading is operator assistance at a contact center. In response to an inquiry from a customer, an operator investigates into various materials such as an instruction manual and a contract document, and makes an answer. At this point, a question and answer technique that involves machine reading is used to shorten the investigation time. Possible answers to the question are found by the question and answer technique involving machine reading, and are displayed to the operator. Since there is a plurality of target documents, it takes time to process all of these documents by machine reading using a neural network. Therefore, each document is divided into small units (passages) such as paragraphs, and passages highly related to the question are narrowed down by an information search technique and are individually read by machine reading, so that answer portions are extracted. The extracted answer portions are displayed as possible answers to the operator, or are displayed in an emphasized manner together with the passages (see Non Patent Literature 3, for example). Such a technology that is a combination of an information search technique and a question and answer technique involving machine reading will be hereinafter referred to as “large-scale machine reading”.

### CITATION LIST

### Non Patent Literature

Non Patent Literature 1: Hwee Tou Ng, Leong Hwee Teo, Jennifer Lai Pheng Kwan:A Machine Learning Approach to Answering Questions for Reading Comprehension Tests. 2000 Joint SIGDAT Conference on Empirical Methods in Natural Language Processing and Very Large Corpora, p. 124-132, 2000
Non Patent Literature 2: M. Seo, A. Kembhavi, A. Farhadi, and H. Hajishirzi. 2017. Bidirectional attention flow for machine comprehension. In ICLR.
Non Patent Literature 3: Kyosuke Nishida, Itsumi Saito, Atsushi Otsuka, Kosuke Nishida, Narichika Nomoto, and Hisako Asano, Toward Natural Language Understanding by Machine Reading Comprehension, NTT Technical Review, Vol. 17, No. 9, pp. 9-14 2019

### SUMMARY OF INVENTION

### Technical Problem

In machine reading using a neural network, a learning model of the neural network is generated, the training data being documents, questions, and simple answers to the questions. Therefore, a result of the machine reading tends to be a short output.

At a contact center, however, an operator accepts various types of questions from customers. For example, there are types of questions that can be briefly answered in one to several words that are compatible with extractive neural machine reading, such as the name of a product that meets a certain condition, the expiration date of a product, and whether a service includes a specific option. On the other hand, there also are types of questions that are expected to provide an explanatory answer that needs to be expressed in multiple sentences or paragraph-level text, such as an overview of a product not known to customers, and the reason why a desired option is not included in a contracted service, for example.

In extractive neural machine reading, there are cases where only part of an expected answer is output in response to a question of a type that expects an explanatory answer like the latter type. Specifically, in response to a question “What are the features of AA?”, for example, text that reads “The features of AA are as follows.” is simply extracted from a passage, and the portion explaining the specific features after the text in the document might not be retrieved. Alternatively, in a case where the conditions for the reasons are complicated, and there is a plurality of sentences that need to be used in response to a question asking for a true/false answer such as “Is BB capable of CC?”, for example, even if it is possible to extract the text describing the reasons for a true/false answer from a passage, it might not be possible to extract all of the reasons. Therefore, for a question that expects an explanatory answer, extractive neural machine reading is not performed, and the passage including the answer is output without any change. In this manner, more appropriate result can be obtained.

In other words, by a conventional question and answer technique, it is not possible to appropriately determine the necessity of extractive neural machine reading in accordance with question types, and therefore, the accuracy of answers to questions is low.

An object of the present disclosure made in view of such circumstances is to provide a question and answer device having an increased accuracy of answers to questions, a question and answer method, and a program.

### Solution to Problem

A question and answer device according to an embodiment is a question and answer device that generates answer data in response to question data, the question and answer device including a question determination unit that receives a predetermined question type into which a feature of the question data is classified and passage data that matches the question data, determines whether machine reading is necessary on the basis of the question type, sets the passage data as the answer data when determining that the machine reading is not necessary, and sets answer text data extracted from the passage data by the machine reading on the basis of the question data and the passage data when determining that the machine reading is necessary.

A question and answer method according to an embodiment is a question and answer method for generating answer data in response to question data, the question and answer method including: a step of receiving a predetermined question type into which a feature of the question data is classified and passage data that matches the question data, and determining whether machine reading is necessary on the basis of the question type; a step of setting the passage data as the answer data when determining that the machine reading is not necessary; and a step of setting answer text data extracted from the passage data by the machine reading on the basis of the question data and the passage data when determining that the machine reading is necessary.

A program according to an embodiment causes a computer to function as the above question and answer device.

### Advantageous Effects of Invention

According to the present disclosure, it is possible to provide a question and answer device having an increased accuracy of answers to questions, a question and answer method, and a program.

### BRIEF DESCRIPTION OF DRAWINGS

FIG. 1 is a diagram illustrating an example configuration of a question and answer device according to a first embodiment.

FIG. 2 is a table showing an example of question data according to the first embodiment.

FIG. 3 is a table showing an example of answer data according to the first embodiment.

FIG. 4 is a table showing an example of question types according to the first embodiment.

FIG. 5 is a table showing an example of passage data according to the first embodiment.

FIG. 6 is a table showing an example of question keyword data corresponding to the question data according to the first embodiment.

FIG. 7 is a table showing an example of passage keyword data corresponding to the passage data according to the first embodiment.

FIG. 8 is a table showing an example of outputs of BERT (Bidirectional Encoder Representations from Transformers) reading according to the first embodiment.

FIG. 9 is a flowchart showing an example of a question and answer method according to the first embodiment.

FIG. 10 is a table showing an example of answer data according to a second embodiment.

FIG. 11 is a flowchart showing an example of a question and answer method according to the second embodiment.

FIG. 12 is a hardware block diagram of a question and answer device according to the present embodiment.

### DESCRIPTION OF EMBODIMENTS

In the description below, modes for carrying out the present invention are explained in detail with reference to the drawings.

### First Embodiment

### <Configuration of a Question And Answer Device>

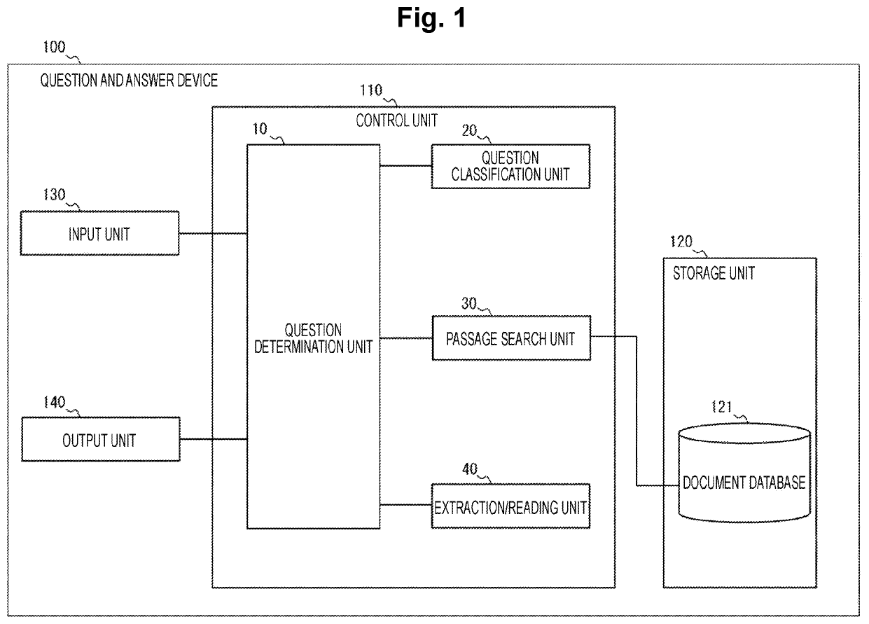

Referring to FIGS. 1 to 8, an example configuration of a question and answer device 100 according to a first embodiment is described.

The question and answer device 100 includes a control unit (a controller) 110, a storage unit 120, an input unit 130, and an output unit 140.

The control unit 110 may be formed with dedicated hardware such as an application specific integrated circuit (ASIC) or a field-programmable gate array (FPGA), may be formed with a general-purpose processor or a processor specialized in specific processing, or may include both dedicated hardware and a processor. The control unit 110 includes a question determination unit 10, a question classification unit 20, a passage search unit 30, and an extraction/reading unit 40.

The storage unit 120 includes one or more memories, and may include a semiconductor memory, a magnetic memory, an optical memory, and the like, for example. Each memory included in the storage unit 120 may function as a main storage device, an auxiliary storage device, or a cache memory, for example. Each memory is not necessarily provided inside the question and answer device 100, but may be provided outside the question and answer device 100. The storage unit 120 stores any information to be used in an operation of the question and answer device 100. The storage unit 120 stores a document database 121, for example. Other than that, the storage unit 120 stores various kinds of programs or data, for example.

The input unit 130 receives inputs of various kinds of information. The input unit 130 may be any kind of device with which the user can perform predetermined operations, and is a microphone, a touch panel, a keyboard, a mouse, or the like, for example. When the user performs a predetermined operation using the input unit 130, for example, question data is input to the control unit 110. The input unit 130 may be provided outside the question and answer device 100, or may be integrated with the question and answer device 100.

The question data is data expressing questions asking what the user wants to know, data prepared by predicting beforehand what the user will want to know, such as Qs in frequently asked questions (FAQ), and the like. Examples of the types of the question data include data directly input by the user using a computer terminal or the like, data output from a computer included in an external device, data selected by the user from among a plurality of pieces of question data accumulated in an external database, and data in which the details of the voice emitted by the user to an artificial intelligence (AI) agent, an AI speaker, or the like are converted into text.

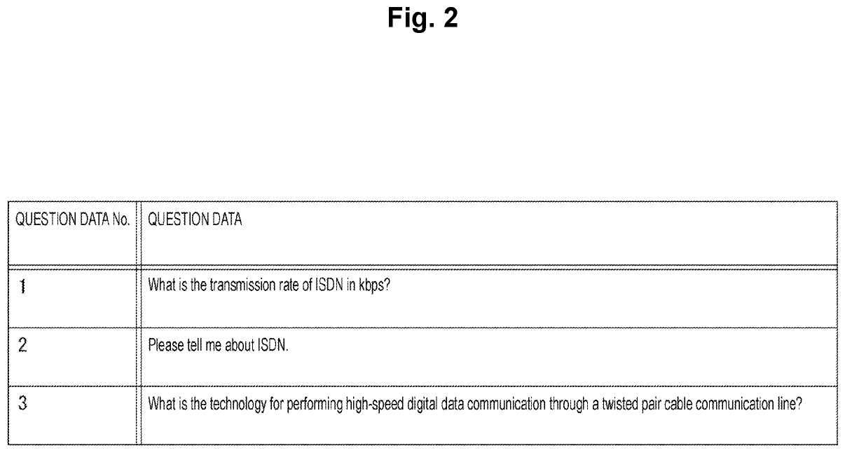

Specifically, as shown in FIG. 2, the question data may be “What is the transmission rate of ISDN in kbps?”, “Please tell me about ISDN”, “What is the technology for performing high-speed digital data communication through a twisted pair cable communication line?”, or the like, for example.

The output unit 140 outputs various kinds of information. The output unit 140 is a speaker, a liquid crystal display, an organic electro-luminescence (EL) display, or the like, for example. The output unit 140 outputs answer data in response to the question data, for example. The output unit 140 may be provided outside the question and answer device 100, or may be integrated with the question and answer device 100.

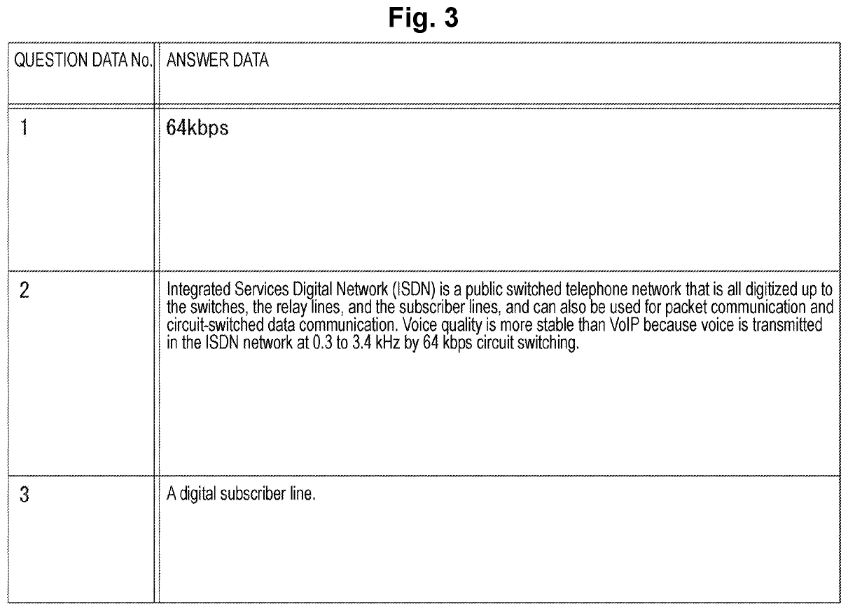

The answer data is data expressing details that the user who asked the questions wants to know. Specifically, as shown in FIG. 3, the answer data may be “64 kbps”, “Integrated Services Digital Network (ISDN) is a public switched telephone network that is all digitized up to the switches, the relay lines, and the subscriber lines, and can also be used for packet communication and circuit-switched data communication. Voice quality is more stable than VoIP because voice is transmitted in the ISDN network at 0.3 to 3.4 kHz by 64 kbps circuit switching.”, “A digital subscriber line”, and the like, for example.

The question determination unit 10 outputs the question data input from the input unit 130, to the question classification unit 20. The question determination unit 10 acquires, from the question classification unit 20, a predetermined question type into which question text data indicating the feature of the question data is classified.

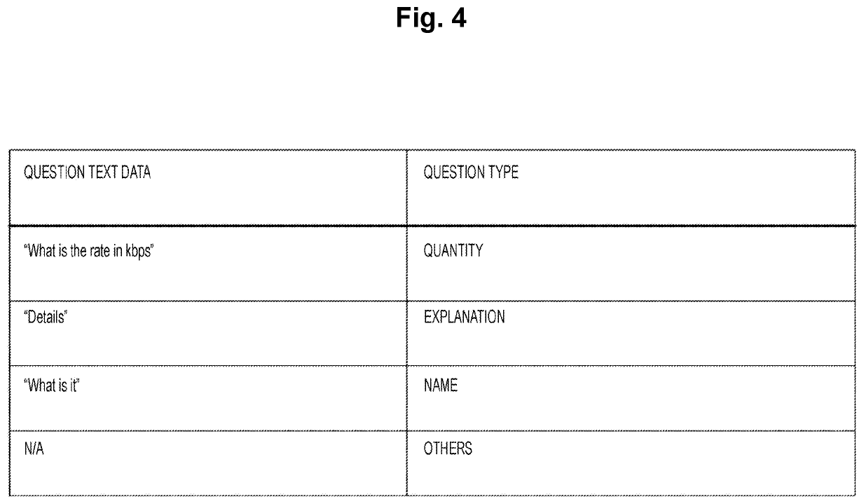

The question text data is data obtained by converting the question data into some feature quantities. Specifically, as shown in FIG. 4, the question text data may be “What is the rate in kbps”, “Details”, “What is it”, and the like, for example.

Predetermined question types are predetermined classification names given to the respective pieces of the question text data. That is, predetermined question types are classification names given to the features of the question data. Specifically, as shown in FIG. 4, the predetermined question types may be “quantity” in response to “What is the rate in kbps”, “explanation” in response to “Details”, “name” in response to “What is it”, and the like, for example. In addition to the above, examples of the predetermined question types include “five W's and an H”, “true/false”, and “others”, but are not limited to them.

For details of the question types, see the following non patent literatures, for example.
Hiroaki Sugiyama, Toyomi Meguro, and Ryuichiro Higashinaka, “Large-scale Collection and Analysis of Personal Questions for Dialogue Agents”, Transactions of the Japanese Society for Artificial Intelligence, DSF-518, 2016
Masaaki Nagata, Kuniko Saito, and Yoshihiro Matsuo, “Japanese Natural Language Search System—Web Answers”, The Twelfth Annual Meeting of the Association for Natural Language Processing, 2006

The question determination unit 10 outputs the question data input from the input unit 130, to the passage search unit 30. The question determination unit 10 acquires, from the passage search unit 30, passage data (possible answers) matching the question data.

The passage data is text data in which a document is divided into small units (passages) such as paragraphs. Passages are not limited to any particular units, but may be in any units that can be automatically or manually divided, and may be paragraphs, sections, subsections, or the like, for example. The passage data is stored in the document database 121.

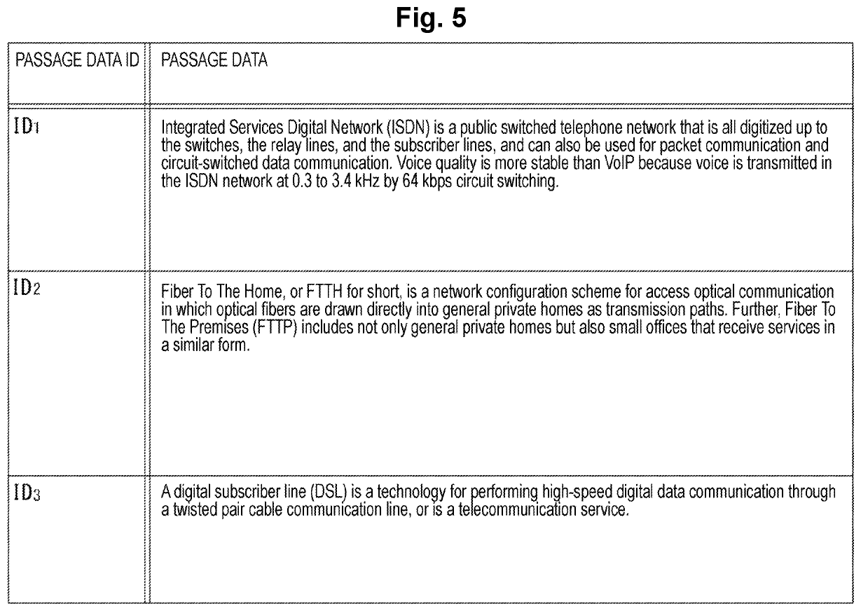

Specifically, as shown in FIG. 5, the passage data may be as follows, for example. ID₁: “Integrated Services Digital Network (ISDN) is a public switched telephone network that is all digitized up to the switches, the relay lines, and the subscriber lines, and can also be used for packet communication and circuit-switched data communication. Voice quality is more stable than VoIP because voice is transmitted in the ISDN network at 0.3 to 3.4 kHz by 64 kbps circuit switching.” ID₂: “Fiber To The Home, or FTTH for short, is a network configuration scheme for access optical communication in which optical fibers are drawn directly into general private homes as transmission paths. Further, Fiber To The Premises (FTTP) includes not only general private homes but also small offices that receive services in a similar form.” ID₃: “A digital subscriber line (DSL) is a technology for performing high-speed digital data communication through a twisted pair cable communication line, or is a telecommunication service.”

The question determination unit 10 determines whether machine reading is necessary, on the basis of a predetermined question type acquired from the question classification unit 20. In a case where the question type is “explanation” or “others”, for example, the question determination unit 10 determines that the user expects an explanatory answer, and in this case, determines that machine reading is unnecessary. In a case where the question type is “quantity” or “name”, for example, the question determination unit 10 determines that the user does not expect an explanatory answer, and in this case, determines that machine reading is necessary.

Alternatively, the question determination unit 10 may determine that machine reading is necessary for items other than those (Clause and Other, for example) predicted to be long in terms of the number of characters in a question type classification (Table 2 in the non patent literature shown below, for example) that is analyzed in a data set created for research on machine reading.
P. Rajpurkar, J. Zhang, K. Lopyrev, and P. Liang. Squad:100,000+ questions for machine comprehension of text. In EMNLP, pp. 2383-2392, 2016

Alternatively, when using a desired classification method, the question determination unit 10 may obtain an average value of the number of characters in the result of machine reading of each classification in advance, and determine that machine reading is necessary in the case of a classification with a smaller number of characters than a preset number.

When determining that machine reading is necessary, the question determination unit 10 outputs, to the extraction/reading unit 40, the question data and the passage data that is obtained from the passage search unit 30 and matches the question data. The question determination unit 10 acquires, from the extraction/reading unit 40, answer text data extracted from the passage data by machine reading. The question determination unit 10 outputs the answer text data as answer data to the output unit 140. The answer text data may be “64 kbps”, “A digital subscriber line”, or the like, for example (see FIG. 3).

When determining that machine reading is not necessary, the question determination unit 10 outputs, to the output unit 140, answer data that is the passage data obtained from the passage search unit 30 and matching the question data. The passage data may be as follows: “Integrated Services Digital Network (ISDN) is a public switched telephone network that is all digitized up to the switches, the relay lines, and the subscriber lines, and can also be used for packet communication and circuit-switched data communication. Voice quality is more stable than VoIP because voice is transmitted in the ISDN network at 0.3 to 3.4 kHz by 64 kbps circuit switching.”, for example (see FIG. 3). Note that, in this case, the question determination unit 10 does not output, to the extraction/reading unit 40, the question data and the passage data obtained from the passage search unit 30 and matching the question data.

As described above, the question determination unit 10 receives (inputs) a predetermined question type into which a feature of the question data is classified and the passage data matching the question data, determines whether machine reading is necessary on the basis of the question type, sets the passage data as answer data when it is determined that machine reading is unnecessary, and sets the answer text data extracted from the passage data by machine reading as answer data on the basis of the question data and the passage data when it is determined that machine reading is necessary. Thus, highly accurate answer data can be efficiently generated. In addition to that, high-precision large-scale machine reading can be performed.

The question classification unit 20 classifies the question text data indicating the features of the question data input from the question determination unit 10, into predetermined question types. The question classification unit 20 outputs a predetermined question type to the question determination unit 10. The question classification unit 20 may set predetermined question types in advance.

The method by which the question classification unit 20 extracts the features of the question data is not limited to any particular method. For example, the question classification unit 20 divides the question data into small units, and converts each unit into a set of features. For example, the question classification unit 20 may set a set of individual characters included in the question data as a set of features. For example, the question classification unit 20 may include a morpheme analyzer, convert the question data into a set of words, a set of morphemes, a set of parts of speech, or the like, and use them as sets of features.

For details of the morpheme analyzer, see the following non patent literature, for example.
Taku Kudo, Kaoru Yamamoto, Yuji Matsumoto: Applying Conditional Random Fields to Japanese Morphological Analysis, Proceedings of the 2004 Conference on Empirical Methods in Natural Language Processing (EMNLP-2004), pp. 230-237 (2004)

The question classification unit 20 determines the question type corresponding to each feature. The method by which the question classification unit 20 determines the question type is not limited to any particular method. For example, the question classification unit 20 associates beforehand words (“when” and “how many”, for example), which are features likely to appear as typical questions, with a question type (“quantity”, for example). In a case where “when” or “how many” appears when the words obtained by dividing a question are used as a set of features, the question classification unit 20 associates these words with “quantity” as a question type. For example, the question classification unit 20 collects a large number of pieces of question data, manually determines which question type is a set of features for each piece of the question data, and conducts the association in advance. Further, the question classification unit 20 may create a classification model of a classifier by machine learning, using the sets of features and the question types as training data. The classifier is not limited to any particular kind, and may be any classifier by supervised machine learning, such as a linear classifier, a support vector machine (SVM), or a neural network, for example. Using the created classifier, the question classification unit 20 then estimates the question type corresponding to the set of features, the input being the set of features that are the words obtained by dividing the question.

The passage search unit 30 searches for passage data that matches the question data input from the question determination unit 10. The passage search unit 30 generates a search request from the question data, and, on the basis of the generated search request, acquires passage data that matches the search request, from the document database 121. The number of pieces of the passage data to be acquired by the passage search unit 30 is not limited to any particular number. In a case where the search request is in the form of text, for example, the passage search unit 30 searches the document database 121 for passage data including the character string constituting the text. In a case where the search request is in the form of a word, for example, the passage search unit 30 searches the document database 121 for passage data including the word. The search request may be any data that expresses the question data, and may be the question data, all of the divided data obtained by dividing the question data into words, or part of the divided data obtained by dividing the question data into words, for example. The passage search unit 30 outputs the passage data matching the question data to the question determination unit 10. In a case where there is no passage data matching the question data in the document database 121, the passage search unit 30 outputs a search result indicating that there is no passage data matching the question data, to the question determination unit 10.

The passage search unit 30 extracts question keyword data from the question data. The passage search unit 30 includes a morpheme analysis system that divides the question data into word strings and gives parts of speech to the divided word strings, for example, and extracts words that are nouns included in the question data, as the question keyword data.

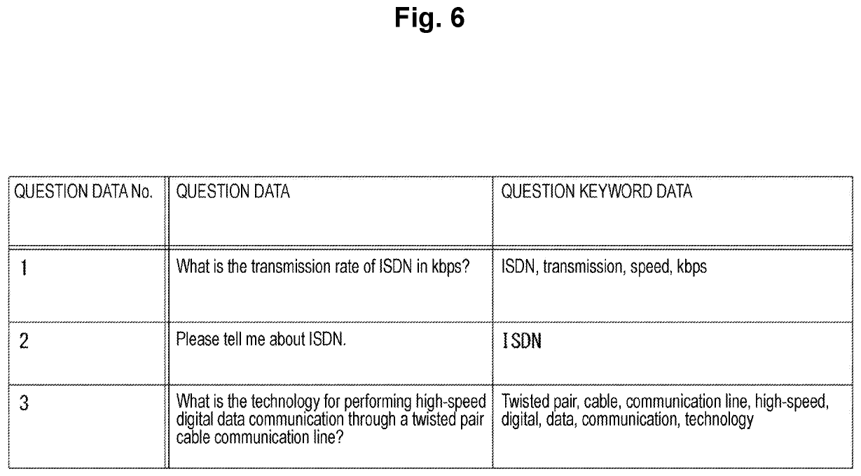

Specifically, as shown in FIG. 6, the question keyword data may be ‘ISDN’, ‘transmission’, ‘rate’, and ‘kbps’ for “What is the transmission rate of ISDN in kbps?”, ‘ISDN’ for “Please tell me about ISDN”, ‘twisted pair’, ‘cable’, ‘communication line’, ‘high-speed’, ‘digital’, ‘data’, ‘communication’, ‘technology’, and the like for “What is the technology for performing high-speed digital data communication through a twisted pair cable communication line?”, for example.

The passage search unit 30 extracts passage keyword data from the passage data. The passage search unit 30 includes a morpheme analysis system that divides the passage data into word strings and gives parts of speech to the divided word strings, for example, and extracts words that are nouns included in the passage data, as the passage keyword data.

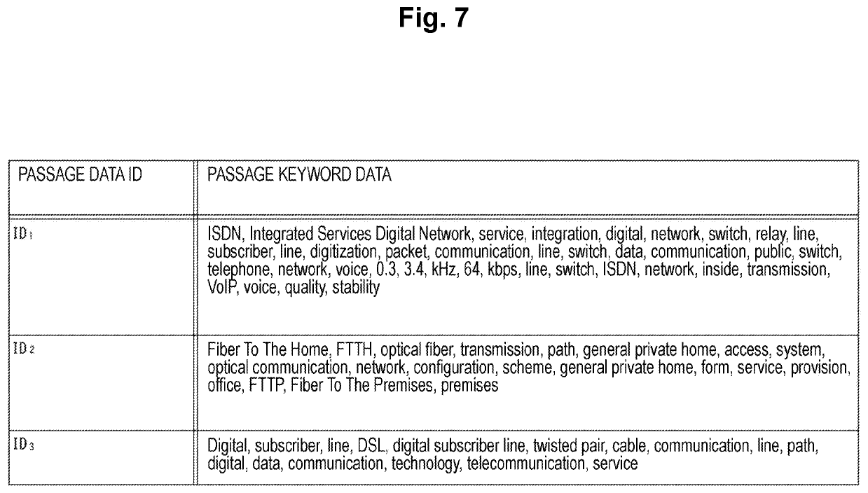

Specifically, as shown in FIG. 7, the passage keyword data may be as follows: ‘ISDN’, ‘Integrated Services Digital Network’, ‘service’, ‘integration’, ‘digital’, ‘network’, ‘switch’, ‘relay’, ‘line’, ‘subscriber’, ‘line’, ‘digitization’, ‘packet’, ‘communication’, ‘line’, ‘switch’, ‘data’, ‘communication’, ‘public’, ‘switch’, ‘telephone’, ‘network’, ‘voice’, ‘0.3’, ‘3.4’, ‘kHz’, ‘64’, ‘kbps’, ‘line’, ‘switch’, ‘ISDN’, ‘network’, ‘inside’, ‘transmission’, ‘VoIP’, ‘voice’, ‘quality’, and ‘stability’ for the passage data having ID₁ as its passage ID; ‘Fiber To The Home’, ‘FTTH’, ‘optical fiber’, ‘transmission’, ‘path’, ‘general private home’, ‘access’, ‘system’, ‘optical communication’, ‘network’, ‘configuration’, ‘scheme’, ‘general private home’, ‘form’, ‘service’, ‘provision’, ‘office’, ‘FTTP’, ‘Fiber To The Promises’, and ‘premises’ for the passage data having ID₂ as its passage ID; and ‘digital’, ‘subscription’, ‘line’, ‘DSL’, ‘digital subscriber line’, ‘twisted pair’, ‘cable’, ‘communication’, ‘line’, ‘path’, ‘digital’, ‘data’, ‘communication’, ‘technology’, ‘telecommunication’, ‘service’, and the like for the passage data having ID₃ as its passage ID.

On the basis of the question keyword data and the passage keyword data, the passage search unit 30 sets the passage data having the higher degree of matching between the question keyword data and the passage keyword data, as the passage data matching the question data.

For example, the passage search unit 30 searches for the passage data including the largest amount of the question keyword data ‘ISDN’, ‘transmission’, ‘rate’, and ‘kbps’ for the question data “What is the transmission rate of ISDN in kbps?”. For example, in the passage data having ID₁ as its passage ID, the number of matches between the question keyword data and the passage keyword data is “three”. For example, in the passage data having ID₂ as its passage ID, the number of matches between the question keyword data and the passage keyword data is “one”. For example, in the passage data having ID₃ as its passage ID, the number of matches between the question keyword data and the passage keyword data is “zero”. Accordingly, the passage search unit 30 determines that the passage data matching the question data “What is the transmission rate of ISDN in kbps?” is the passage data having ID₁ as its passage ID.

The document database 121 is a database that accumulates passage data that is extracted from a plurality of documents such as an instruction booklet and a document extracted from a free encyclopedia (Wikipedia, for example) on the Internet, and is divided into smaller units than the documents. In the document database 121, an index may be created in advance. By referring to the index, the passage search unit 30 can search for the passage data matching the question data at high speed. Note that the storage unit 120 stores the document database 121 in advance.

On the basis of the pair of the question data and the passage data input from the question determination unit 10, the extraction/reading unit 40 extracts answer text data from the passage data, using machine reading by a neural network. For example, the extraction/reading unit 40 generates a neural network learning model, using training data that is prepared in advance and includes question data, passage data, and a large number of pieces of data having positions (the start points and the end points) of the character strings in the text data included in the passage data as units. Note that the learning model is not necessarily a model using a neural network. Using the learning model, the extraction/reading unit 40 then extracts a character string that is the optimum answer to the question as answer text data, on the basis of unknown question data and passage data. The extraction/reading unit 40 outputs the answer text data to the question determination unit 10.

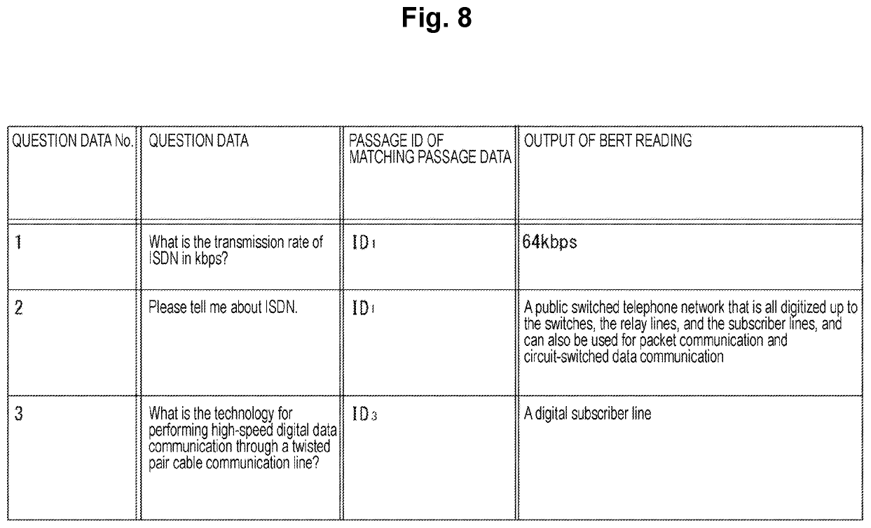

FIG. 8 is a table showing an example output of machine reading using a BERT model (hereinafter, this reading will be referred to as “BERT reading”). For example, the extraction/reading unit 40 extracts the answer text data “64 kbps” as the output of the BERT reading, on the basis of the question data “What is the transmission rate of ISDN in kbps?” and the passage data that has ID₁ as its passage ID and matches the question data. For example, the extraction/reading unit 40 extracts the answer text data “A public switched telephone network that is digitized up to the switches, the relay lines, and the subscriber lines, and can also be used for packet communication and circuit-switched data communication” as the output of the BERT reading, on the basis of the question data “Please tell me about ISDN” and the passage data that has ID₁ as its passage ID and matches the question data. For example, the extraction/reading unit 40 extracts the answer text data “A digital subscriber line” as the output of the BERT reading, on the basis of the question data “What is the technology for performing high-speed digital data communication through a twisted pair cable communication line” and the passage data that has ID₃ as its passage ID and matches the question data.

The question and answer device 100 according to the first embodiment can generate highly accurate answer data by appropriately determining the necessity/unnecessity of machine reading in accordance with the question type. Thus, the question and answer device 100 with an increased answer accuracy for questions can be provided. Furthermore, unnecessary machine reading is not performed, and thus, the costs of calculation by a GPU of a computer can be greatly lowered. Also, the question and answer device 100 capable of high-precision large-scale machine reading can be provided.

### <Question and Answer Method>

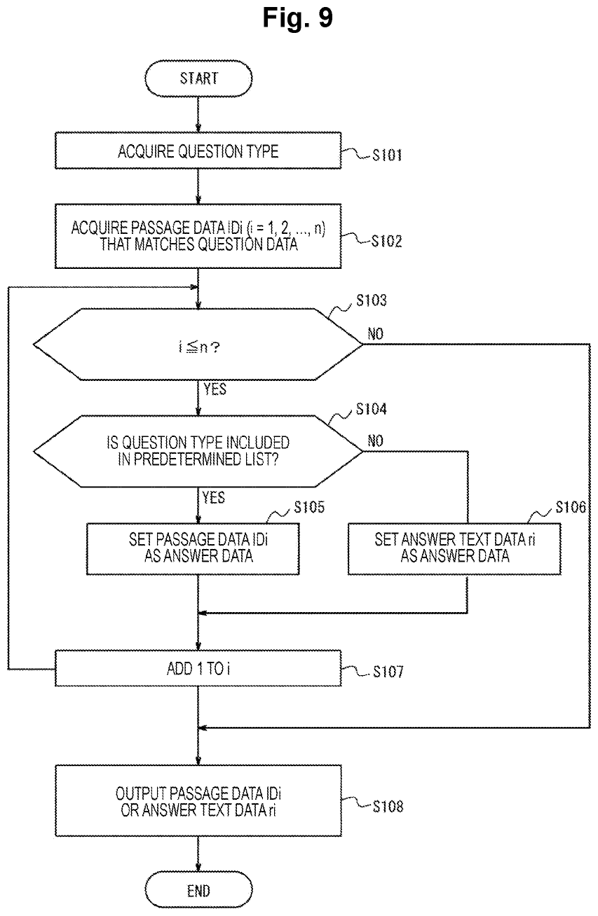

Referring now to FIG. 9, an example of a question and answer method according to the first embodiment is described.

In step 101, the question determination unit 10 acquires, from the question classification unit 20, the question type into which question text data included in question data is classified.

In step 102, the question determination unit 10 acquires, from the passage search unit 30, passage data IDᵢ (i=1, 2, . . . , n) matching the question data.

In step 103, the question determination unit 10 determines whether i is smaller than n. If the question determination unit 10 determines that i is equal to or smaller than n (step 103→YES), the question determination unit 10 performs the process in step 104. If the question determination unit 10 determines that i is larger than n (step 103→NO), the question determination unit 10 performs the process in step 108.

In step 104, the question determination unit 10 determines whether the question type is included in a predetermined list, or whether machine reading is necessary. If the question determination unit 10 determines that the question type is included in the predetermined list, or the machine reading is unnecessary (step 104→YES), the question determination unit 10 performs the process in step 105. If the question determination unit 10 determines that the question type is not included in the predetermined list, or the machine reading is necessary (step 104→NO), the question determination unit 10 performs the process in step 106. The predetermined list is the above-described list including “explanation” and “others”, for example (see FIG. 4). In other words, a question type being included in the predetermined list means that the question type corresponds to “explanation” or “others”, for example. Also, a question type not being included in the predetermined list means that the question type corresponds to “quantity” or “name”, for example.

In step 105, the question determination unit 10 sets the passage data IDᵢ obtained from the passage search unit 30 and matching the question data, as answer data.

In step 106, the question determination unit 10 outputs, to the extraction/reading unit 40, the question data and the passage data IDᵢ obtained from the passage search unit 30 and matching the question data, acquires, from the extraction/reading unit 40, answer text data rᵢ extracted from the passage data IDᵢ by machine reading, and sets the answer text data rᵢ as answer data.

In step 107, the question determination unit 10 adds 1 to i, and again performs the process in step 103.

In step 108, the question determination unit 10 outputs, to the output unit 140, the passage data IDᵢ or the answer text data rᵢ as answer data.

By the above question and answer method, it is possible to generate highly accurate answer data by appropriately determining the necessity/unnecessity of machine reading in accordance with the question type. Thus, a question and answer method with an increased answer accuracy for questions can be implemented.

### Second Embodiment

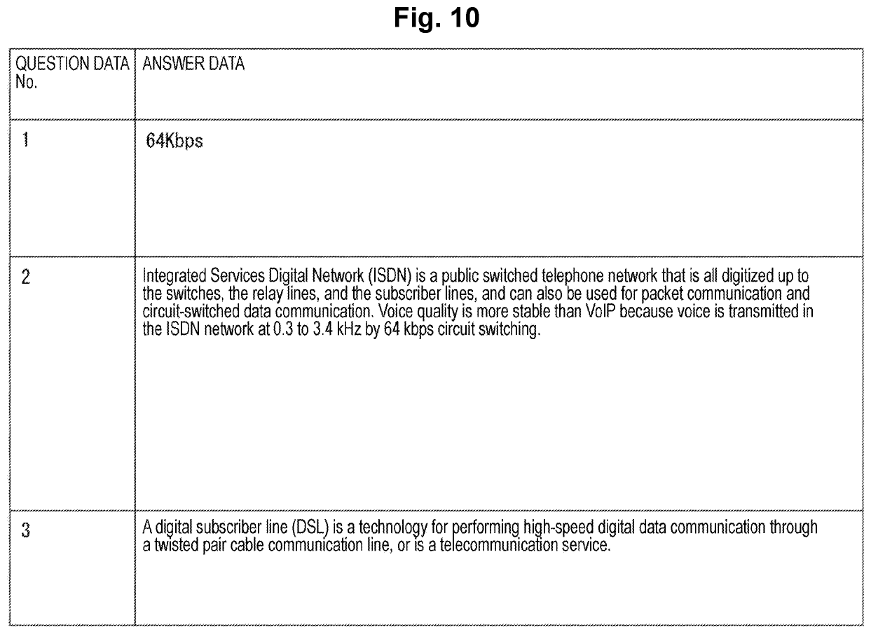

Referring now to FIG. 10, an example configuration of a question and answer device 100A according to a second embodiment is described.

The question and answer device 100A according to the second embodiment differs from the question and answer device 100 according to the first embodiment in that a question determination unit 10A first determines whether to use passage data as answer data on the basis of the number of characters in the passage data, before determining whether machine reading is necessary on the basis of a predetermined question type acquired from the question classification unit 20. The other components are the same as those of the first embodiment, and therefore, explanation thereof is not made herein.

The question and answer device 100A includes a control unit 110A, a storage unit 120, an input unit 130, and an output unit 140. The control unit 110A includes a question determination unit 10A, a question classification unit 20, a passage search unit 30, and an extraction/reading unit 40.

The question determination unit 10A counts the number of characters in the passage data that matches question data acquired from the passage search unit 30. For example, the number of characters in the passage data having ID₁ as its passage ID is 190. For example, the number of characters in the passage data having ID₂ as its passage ID is 191. For example, the number of characters in the passage data having ID₃ as its passage ID is 98.

On the basis of whether the counted number of characters in the passage data is smaller than a threshold, the question determination unit 10A determines whether to use the passage data as answer data. The threshold may be set in advance, and may be set as appropriate to 30 characters, 100 characters, or the like, for example. The index to be used by the question determination unit 10A to perform determination may be the number of the words included in the passage data. The index is not limited to any particular kind, and may be an index that indicates at least the number of the characters included in the passage data.

In a case where the counted number of characters in the passage data is smaller than the threshold, the question determination unit 10A determines that the passage data is to be answer data, and outputs the passage data as answer data to the output unit 140. For example, in a case where the number of characters (98 characters) in the passage data having ID₃ as its passage ID is smaller than the threshold (100 characters, for example), the question determination unit 10A determines that the passage data having ID₃ as its passage ID is to be answer data, and outputs the passage data ID₃ as answer data to the output unit 140 (see the answer data corresponding to question data No. 3 in FIG. 10). Note that, in this case, the question determination unit 10A does not output, to the extraction/reading unit 40, the question data and the passage data obtained from the passage search unit 30 and matching the question data.

In a case where the counted number of characters in the passage data is equal to or larger than the threshold, the question determination unit 10A determines that the passage data is not to be answer data, and further determines whether machine reading is necessary on the basis of the predetermined question type acquired from the question classification unit 20. For example, in a case where the number of characters (190 characters) in the passage data having ID₁ as its passage ID is equal to or larger than the threshold (100 characters, for example), the question determination unit 10A determines that the passage data having ID₁ as its passage ID is not to be answer data. Further, in a case where the number of characters (191 characters) in the passage data having ID₂ as its passage ID is equal to or larger than the threshold (100 characters, for example), the question determination unit 10A determines that the passage data having ID₂ as its passage ID is not to be answer data, for example.

When determining that machine reading is necessary, the question determination unit 10A outputs, to the extraction/reading unit 40, the question data and the passage data that is obtained from the passage search unit 30 and matches the question data. The question determination unit 10A acquires, from the extraction/reading unit 40, answer text data extracted from the passage data by machine reading. The question determination unit 10A outputs the answer text data as answer data to the output unit 140. For example, the question determination unit 10A outputs answer text data “64 kbps” as answer data to the output unit 140 (see the answer data corresponding to question data No. 1 in FIG. 10).

When determining that machine reading is not necessary, on the other hand, the question determination unit 10A outputs, to the output unit 140, answer data that is the passage data obtained from the passage search unit 30 and matching the question data. For example, the question determination unit 10A outputs, to the output unit 140, the passage data whose passage ID is ID₂ as answer data (see the answer data corresponding to question data No. 2 in FIG. 10). Note that, in this case, the question determination unit 10A does not output, to the extraction/reading unit 40, the question data and the passage data obtained from the passage search unit 30 and matching the question data.

The question and answer device 100A according to the second embodiment can generate highly accurate answer data by first determining whether to set the passage data as answer data on the basis of the number of characters in the passage data, and then appropriately determining whether machine reading is necessary in accordance with the question type. Thus, the question and answer device 100A with an increased answer accuracy for questions can be provided. For example, in a case where each passage is expressed in about several words or one sentence on the screen of a computer terminal, the operator can quickly view and understand the passages. Therefore, although there is no need to perform machine reading, machine reading is uniformly performed on all the passages by a conventional technique. Because such a problem is avoided, and unnecessary machine reading is not performed, the costs of calculation by a GPU of a computer can be greatly lowered. Also, the question and answer device 100A capable of high-precision large-scale machine reading can be provided.

### <Question and Answer Method>

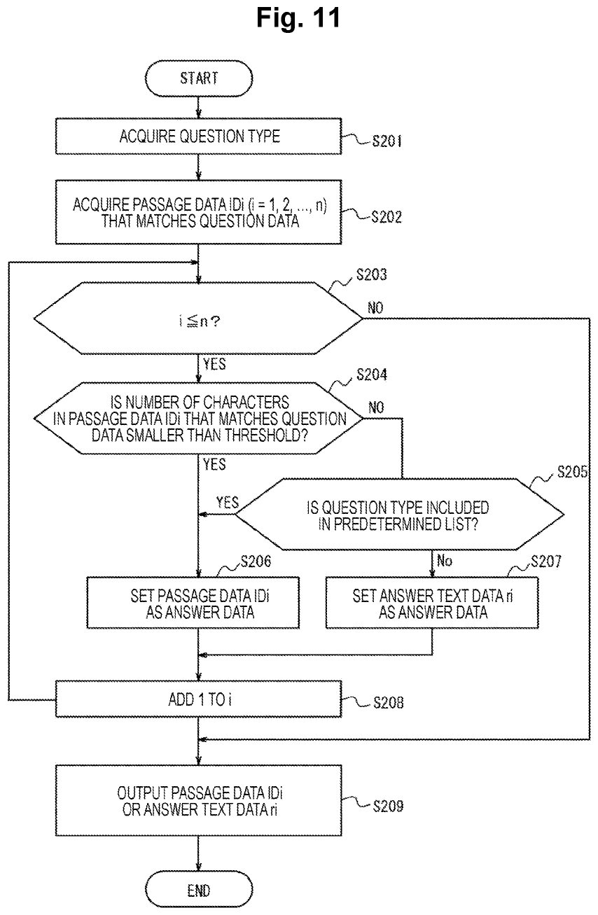

Referring now to FIG. 11, an example of a question and answer method according to the second embodiment is described.

In step 201, the question determination unit 10A acquires, from the question classification unit 20, the question type into which question text data indicating question data is classified.

In step 202, the question determination unit 10A acquires, from the passage search unit 30, passage data IDᵢ (i=1, 2, . . . , n) matching the question data.

In step 203, the question determination unit 10A determines whether i is smaller than n. If the question determination unit 10A determines that i is equal to or smaller than n (step 203→YES), the question determination unit 10A performs the process in step 204. If the question determination unit 10A determines that i is larger than n (step 203→NO), the question determination unit 10A performs the process in step 208.

In step 204, the question determination unit 10A determines whether the number of characters in the passage data that has been obtained from the passage search unit 30 and matches the question data is smaller than the threshold. If the number of characters in the passage data matching the question data obtained from the passage search unit 30 is smaller than the threshold (step 204→YES), the question determination unit 10A performs the process in step 206. If the number of characters in the passage data matching the question data obtained from the passage search unit 30 is equal to or larger than the threshold (step 204→NO), the question determination unit 10A performs the process in step 205.

In step 205, the question determination unit 10A determines whether the question type is included in a predetermined list, or whether machine reading is necessary. If the question determination unit 10A determines that the question type is included in the predetermined list, or the machine reading is unnecessary (step 205→YES), the question determination unit 10A performs the process in step 206. If the question determination unit 10A determines that the question type is not included in the predetermined list, or the machine reading is necessary (step 205→NO), the question determination unit 10A performs the process in step 207.

In step 206, the question determination unit 10A sets the passage data IDᵢ obtained from the passage search unit 30 and matching the question data, as answer data.

In step 207, the question determination unit 10A outputs, to the extraction/reading unit 40, the question data and the passage data IDᵢ obtained from the passage search unit 30 and matching the question data, acquires, from the extraction/reading unit 40, answer text data rᵢ extracted from the passage data IDᵢ by machine reading, and sets the answer text data rᵢ as answer data.

In step 208, the question determination unit 10A adds 1 to i, and again performs the process in step 203.

In step 209, the question determination unit 10A outputs, to the output unit 140, the passage data IDᵢ or the answer text data rᵢ as answer data.

By the question and answer method described above, it is possible to generate highly accurate answer data by first determining whether to set the passage data as answer data on the basis of the number of characters in the passage data, and then appropriately determining whether machine reading is necessary in accordance with the question type. Thus, a question and answer method with an increased answer accuracy for questions can be implemented.

### <Modifications>

In each of the above embodiments, a case where the question and answer device 100 or 100A uses extractive machine reading has been described as an example. However, the type of machine reading is not limited to this. For example, the question and answer device 100 or 100A may use generative machine reading that does not limit answer data within the range of passage data.

Further, in each of the above embodiments, a case where one piece of question data is input to the question and answer device 100 or 100A has been described as an example. However, a plurality of pieces of question data may be input. In a case where a plurality of pieces of question data is input, the question and answer device 100 or 100A repeatedly performs a process of receiving an input of question data piece by piece and outputting answer data.

### <Program>

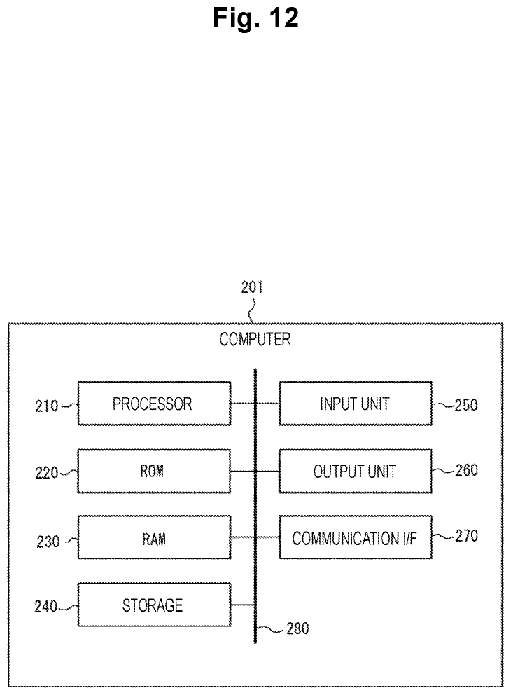

Each of the question and answer devices 100 and 100A described above can be implemented by a computer 201. A program causing a computer to function as the question and answer device 100 or 100A may be provided. The program may be stored in a storage medium or may be provided through a network. FIG. 12 is a block diagram illustrating a schematic configuration of the computer 201 that functions as the question and answer device 100 or 100A. Here, the computer 201 may be a general-purpose computer, a dedicated computer, a workstation, a personal computer (PC), an electronic note pad, or the like. A program instruction may be a program code, a code segment, or the like for executing a required task.

As illustrated in FIG. 12, the computer 201 includes a processor 210, a read only memory (ROM) 220, a random access memory (RAM) 230, a storage 240, an input unit 250, an output unit 260, and a communication interface (I/F) 270. The components are communicably connected to one another via a bus 280. Specifically, the processor 210 is a central processing unit (CPU), a micro processing unit (MPU), a graphics processing unit (GPU), a digital signal processor (DSP), a system on a chip (SoC), or the like, and may be formed with a plurality of processors of the same type or different types.

The processor 210 controls the respective components and performs various kinds of arithmetic processing. That is, the processor 210 reads a program from the ROM 220 or the storage 240, and executes the program, using the RAM 230 as the work area. The processor 210 controls the respective components described above and performs various kinds of arithmetic processing, in accordance with the program stored in the ROM 220 or the storage 240. In the embodiments described above, a program according to the present disclosure is stored in the ROM 220 or the storage 240.

The program may be stored in a storage medium that can be read by the computer 201. With such a storage medium, it is possible to install the program into the computer 201. Here, the storage medium in which the program is stored may be a non-transitory storage medium. The non-transitory storage medium is not limited to any particular kind, but may be a CD-ROM, a DVD-ROM, a universal serial bus (USB) memory, or the like, for example. Alternatively, the program may be downloaded from an external device via a network.

The ROM 220 stores various programs and various kinds of data. The RAM 230 as a work area temporarily stores programs or data. The storage 240 is formed with a hard disk drive (HDD) or a solid state drive (SSD), and stores various programs including an operating system and various kinds of data.

The input unit 250 includes one or more input interfaces that receive the user's input operations and acquire information based on the user's operations. The input unit 250 is a pointing device, a keyboard, a mouse, or the like, for example, but is not limited to them.

The output unit 260 includes one or more output interfaces that output information. The output unit 260 is a display that outputs information as video images, or a speaker that outputs information as sound, for example, but is not limited to them. Note that the output unit 260 also functions as the input unit 250 in a case where the output unit 260 is a touch-panel display.

The communication interface (I/F) 270 is an interface for communicating with an external device.

Regarding the above embodiments, the following supplementary notes are further disclosed.

### (Supplementary Note 1)

A question and answer device that generates answer data in response to question data,
the question and answer device including:
a memory; and
at least one controller connected to the memory,
wherein
the controller
receives a predetermined question type into which a feature of the question data is classified, and passage data that matches the question data,
determines whether machine reading is necessary, on the basis of the question type, and
sets the passage data as the answer data when determining that the machine reading is not necessary, and sets answer text data extracted from the passage data by the machine reading on the basis of the question data and the passage data when determining that the machine reading is necessary.

### (Supplementary Note 2)

The question and answer device according to supplementary note 1, wherein
the controller
classifies the feature of the question data into the question type,
searches for the passage data, and
extracts answer text data from the passage data by machine reading, on the basis of the question data and the passage data.

### (Supplementary Note 3)

The question and answer device according to supplementary note 1 or 2, wherein
the controller determines whether the number of characters in the passage data is smaller than a threshold before determining whether the machine reading is necessary, and, when the number of characters is smaller than the threshold, sets the passage data as the answer data.

### (Supplementary Note 4)

A question and answer method implemented by a question and answer device that generates answer data in response to question data,
the question and answer method including:
a step of receiving a predetermined question type into which a feature of the question data is classified, and passage data that matches the question data;
a step of determining whether machine reading is necessary, on the basis of the question type;
a step of setting the passage data as the answer data when determining that the machine reading is not necessary; and
a step of setting answer text data extracted from the passage data by the machine reading on the basis of the question data and the passage data when determining that the machine reading is necessary.

### (Supplementary Note 5)

A non-transitory storage medium storing a program to be executed by a computer,
the program causing the computer to function as the question and answer device according to any one of Supplementary Notes 1 to 3.

Although the above embodiments have been described as typical examples, it is obvious to those skilled in the art that many modifications and substitutions can be made within the spirit and scope of the present disclosure. Accordingly, the present invention should not be interpreted as being limited by the above embodiments, and various modifications and changes can be made within the scope of the claims. For example, a plurality of functional blocks illustrated in the configuration diagrams of the embodiments can be combined into one, or one functional block can be divided. Also, a plurality of steps shown in the flowcharts of the embodiments can be combined into one, or one step can be divided.

### REFERENCE SIGNS LIST

10, 10A question determination unit
20 question classification unit
30 passage search unit
40 extraction/reading unit
100, 100A question and answer device
110, 110A control unit
120 storage unit
121 document database
130 input unit
140 output unit

1. A question and answer device that generates answer data in response to question data,
the question and answer device comprising:
question determination circuitry that receives a predetermined question type into which a feature of the question data is classified and passage data that matches the question data, determines whether machine reading is necessary on a basis of the question type, sets the passage data as the answer data when determining that the machine reading is not necessary, and sets answer text data extracted from the passage data by the machine reading on a basis of the question data and the passage data when determining that the machine reading is necessary.

2. The question and answer device according to claim 1, further comprising:
question classification circuitry that classifies the feature of the question data into the question type,
passage search circuitry that searches for the passage data, and
extraction/reading circuitry that extracts the answer text data from the passage data by the machine reading, on a basis of the question data and the passage data.

3. The question and answer device according to claim 1, wherein the question determination circuitry determines whether the number of characters in the passage data is smaller than a threshold before determining whether the machine reading is necessary, and, when the number of characters is smaller than the threshold, sets the passage data as the answer data.

4. A question and answer method implemented by a question and answer device that generates answer data in response to question data,
the question and answer method comprising:
receiving a predetermined question type into which a feature of the question data is classified, and passage data that matches the question data;
determining whether machine reading is necessary, on a basis of the question type;
setting the passage data as the answer data when determining that the machine reading is not necessary; and
setting answer text data extracted from the passage data by the machine reading on a basis of the question data and the passage data when determining that the machine reading is necessary.

5. A program for causing a computer to function as the question and answer device according to claim 1.

6. The question and answer device according to claim 2, wherein
the question determination unit determines whether the number of characters in the passage data is smaller than a threshold before determining whether the machine reading is necessary, and, when the number of characters is smaller than the threshold, sets the passage data as the answer data.

7. The question and answer device according to claim 2, further comprising:
the question determination circuitry determines machine reading is necessary based on a predetermined question type acquired from the question classification circuitry.

8. The question and answer device according to claim 1, wherein a generative machine reading is used when the answer data exceeds the range of passage data.

9. The question and answer device according to claim 1, wherein the question data used as the input comprises a plurality of pieces of question data.

10. The question and answer method according to claim 4, wherein a generative machine reading is used when the answer data exceeds the range of passage data.

11. The question and answer method according to claim 4, wherein the question data used as the input comprises a plurality of pieces of question data.
